(19) United States
(12) Patent Application Publication
(10) Pub. No.: US 2014/0071235 A1
(43) Pub. Date: Mar. 13, 2014

(54) INTER-VIEW MOTION PREDICTION FOR 3D VIDEO

(71) Applicant: QUALCOMM Incorporated, San Diego, CA (US)

(72) Inventors: Li Zhang, San Diego, CA (US); Ying Chen, San Diego, CA (US); Marta Karczewicz, San Diego, CA (US)

(73) Assignee: QUALCOMM Incorporated, San Diego, CA (US)

(21) Appl. No.: 14/024,058

(22) Filed: Sep. 11, 2013

Related U.S. Application Data
(60) Provisional application No. 61/700,765, filed on Sep. 13, 2012.
(60) Provisional application No. 61/709,013, filed on Oct. 2, 2012.

(51) Int. Cl. H04N 7/32

(52) U.S. Cl. CPC H04N 19/00769
USPC 348/43

(57) ABSTRACT

This disclosure describes techniques for improving coding efficiency of motion prediction in multiview and 3D video coding. In one example, a method of decoding video data comprises deriving one or more disparity vectors for a current block, the disparity vectors being derived from neighboring blocks relative to the current block, converting a disparity vector to one or more of inter-view predicted motion vector candidates and inter-view disparity motion vector candidates, adding the one or more inter-view predicted motion vector candidates and the one or more inter-view disparity motion vector candidates to a candidate list for a motion vector prediction mode, and decoding the current block using the candidate list.

This application claims the benefit of U.S. Provisional Application No. 61/700,765, filed Sep. 13, 2012, and U.S. Provisional Application No. 61/709,013, filed Oct. 2, 2012, the entire content of both of which is incorporated by reference herein.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for improving coding efficiency of motion prediction in multiview and 3D video coding.

In one example of the disclosure, a method of decoding video data comprises deriving one or more disparity vectors for a current block, the disparity vectors being derived from neighboring blocks relative to the current block, converting a disparity vector to one or more of inter-view predicted motion vector candidates and inter-view disparity motion vector candidates, adding the one or more inter-view predicted motion vector candidates and the one or more inter-view disparity motion vector candidates to a candidate list for a motion vector prediction mode, and decoding the current block using the candidate list.

In another example of the disclosure, a method of decoding video data comprises deriving one or more disparity vectors for a current block, the disparity vectors being derived from neighboring blocks relative to the current block, converting a disparity vector to one of an inter-view predicted motion vector and/or an inter-view disparity motion vector, adding the inter-view predicted motion vector and/or the inter-view disparity motion vector to a candidate list for a motion vector prediction mode, and decoding the current block using the candidate list.

The techniques of this disclosure further including pruning the candidate list based on a comparison of the added inter-view predicted motion vector to other candidate motion vectors in the candidate list.

This disclosure also describes apparatuses, devices, and computer-readable media configured to carry out the disclosed methods and techniques.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the inter-prediction techniques of this disclosure.

FIG. 2 is a conceptual diagram illustrating an example decoding order for multi-view video.

FIG. 3 is a conceptual diagram illustrating an example prediction structure for multi-view video.

FIG. 4 shows an example set of candidate blocks that may be used in both merge mode and AMVP mode.

FIG. 5 is a conceptual diagram illustrating textures and depth values for 3D video.

FIG. 6 is a conceptual diagram illustrating an example derivation process of an inter-view predicted motion vector candidate.

FIG. 7 is a block diagram illustrating an example of a video encoder that may implement the inter-prediction techniques of this disclosure.

FIG. 8 is a block diagram illustrating an example of a video decoder that may implement the inter-prediction techniques of this disclosure.

FIG. 9 is a flowchart showing an example encoding process according to the techniques of the disclosure.

FIG. 10 is a flowchart showing an example encoding process according to the techniques of the disclosure.

FIG. 11 is a flowchart showing an example decoding process according to the techniques of the disclosure.

FIG. 12 is a flowchart showing an example decoding process according to the techniques of the disclosure.

### DETAILED DESCRIPTION

To produce a three-dimensional effect in video, two views of a scene, e.g., a left eye view and a right eye view, may be shown simultaneously or nearly simultaneously. Two pictures of the same scene, corresponding to the left eye view and the right eye view of the scene, may be captured (or generated, e.g., as computer-generated graphics) from slightly different horizontal positions, representing the horizontal disparity between a viewer's left and right eyes. By displaying these two pictures simultaneously or nearly simultaneously, such that the left eye view picture is perceived by the viewer's left eye and the right eye view picture is perceived by the viewer's right eye, the viewer may experience a three-dimensional video effect. In some other cases, vertical disparity may be used to create a three-dimensional effect.

In general, this disclosure describes techniques for coding and processing multiview video data and/or multiview texture plus depth video data, where texture information generally describes luminance (brightness or intensity) and chrominance (color, e.g., blue hues and red hues) of a picture. Depth information may be represented by a depth map, in which individual pixels of the depth map are assigned values that indicate whether corresponding pixels of the texture picture are to be displayed at the screen, relatively in front of the screen, or relatively behind the screen. These depth values may be converted into disparity values when synthesizing a picture using the texture and depth information.

This disclosure describes techniques for improving the efficiency and quality of inter-view prediction in multi-view and/or multi-view plus depth (e.g., 3D-HEVC) video coding. In particular, this disclosure proposes techniques for improving the quality of motion vector prediction for inter-view motion prediction when using disparity vectors to populate a motion vector prediction candidate list.

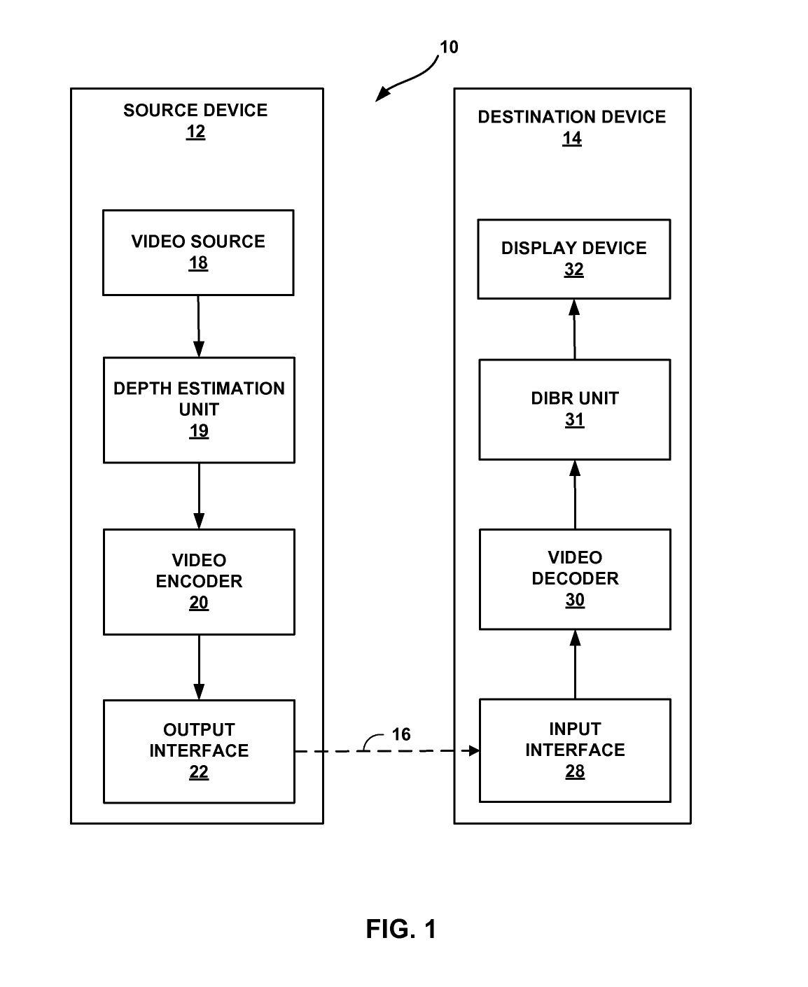

FIG. 1 is a block diagram illustrating an example video encoding and decoding system 10 that may utilize techniques of this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, depth estimation unit 19, video encoder 20, and output interface 22. Destination device 14 includes input interface 28, video decoder 30, depth image based rendering (DIBR) unit 31, and display device 32. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. The techniques of this disclosure may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Video source 18 may provide multiple views of video data to video encoder 20. For example, video source 18 may correspond to an array of cameras, each having a unique horizontal position relative to a particular scene being filmed. Alternatively, video source 18 may generate video data from disparate horizontal camera perspectives, e.g., using computer graphics. Depth estimation unit 19 may be configured to determine values for depth pixels corresponding to pixels in a texture image. For example, depth estimation unit 19 may represent a Sound Navigation and Ranging (SONAR) unit, a Light Detection and Ranging (LIDAR) unit, or other unit capable of directly determining depth values substantially simultaneously while recording video data of a scene.

Additionally or alternatively, depth estimation unit 19 may be configured to calculate depth values indirectly by comparing two or more images that were captured at substantially the same time from different horizontal camera perspectives. By calculating horizontal disparity between substantially similar pixel values in the images, depth estimation unit 19 may approximate depth of various objects in the scene. Depth estimation unit 19 may be functionally integrated with video source 18, in some examples. For example, when video source 18 generates computer graphics images, depth estimation unit 19 may provide actual depth maps for graphical objects, e.g., using z-coordinates of pixels and objects used to render texture images.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device. In some examples, display device 32 may comprise a device capable of displaying two or more views simultaneously or substantially simultaneously, e.g., to produce a 3D visual effect for a viewer.

DIBR unit 31 of destination device 14 may render synthesized views using texture and depth information of decoded views received from video decoder 30. For example, DIBR unit 31 may determine horizontal disparity for pixel data of texture images as a function of values of pixels in corresponding depth maps. DIBR unit 31 may then generate a synthesized image by offsetting pixels in a texture image left or right by the determined horizontal disparity. In this manner, display device 32 may display one or more views, which may correspond to decoded views and/or synthesized views, in any combination. In accordance with the techniques of this disclosure, video decoder 30 may provide original and updated precision values for depth ranges and camera parameters to DIBR unit 31, which may use the depth ranges and camera parameters to properly synthesize views.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards, such as the MVC extension of ITU-T H.264/AVC. In particular, the techniques of this disclosure are related to multiview and/or 3D video coding based on advanced codecs. In general, the techniques of this disclosure may be applied to any of a variety of different video coding standards. For example, these techniques may be applied to the multi-view video coding (MVC) extension of ITU-T H.264/AVC (advanced video coding), to a 3D video (3DV) extension of the upcoming HEVC standard (e.g., 3D-HEVC), or other coding standard.

A recent draft of the upcoming HEVC standard is described in document HCTVC-J1003, Bross et al., “High Efficiency Video Coding (HEVC) Text Specification Draft 8,” Joint Collaborative Team on Video Coding (JCT-VC) of ITU-T SG16 WP3 and ISO/IEC JTC1/SC29/WG11, 10th Meeting: Stockholm, Sweden, Jul. 11, 2012 to Jul. 12, 2012, which, as of Jun. 7, 2013, is downloadable from http://phenix.int-evey.fr/jct/doc_end user/documents/10_Stockholm/wg11/JCTVC-J1003-v8.zip. For purposes of illustration, the techniques of this disclosure are described primarily with respect to the 3 DV extension of HEVC. However, it should be understood that these techniques may be applied to other standards for coding video data used to produce a three-dimensional effect as well.

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

Initially, example coding techniques of HEVC will be discussed. The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three angular intra-prediction encoding modes plus DC and Planar modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or merge mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In this section, multiview and multiview plus depth coding techniques will be discussed. Initially, MVC techniques will be discussed. As noted above, MVC is an extension of ITU-T H.264/AVC. In MVC, data for a plurality of views is coded in time-first order, and accordingly, the decoding order arrangement is referred to as time-first coding. In particular, view components (that is, pictures) for each of the plurality of views at a common time instance may be coded, then another set of view components for a different time instance may be coded, and so on. An access unit may include coded pictures of all of the views for one output time instance. It should be understood that the decoding order of access units is not necessarily identical to the output (or display) order.

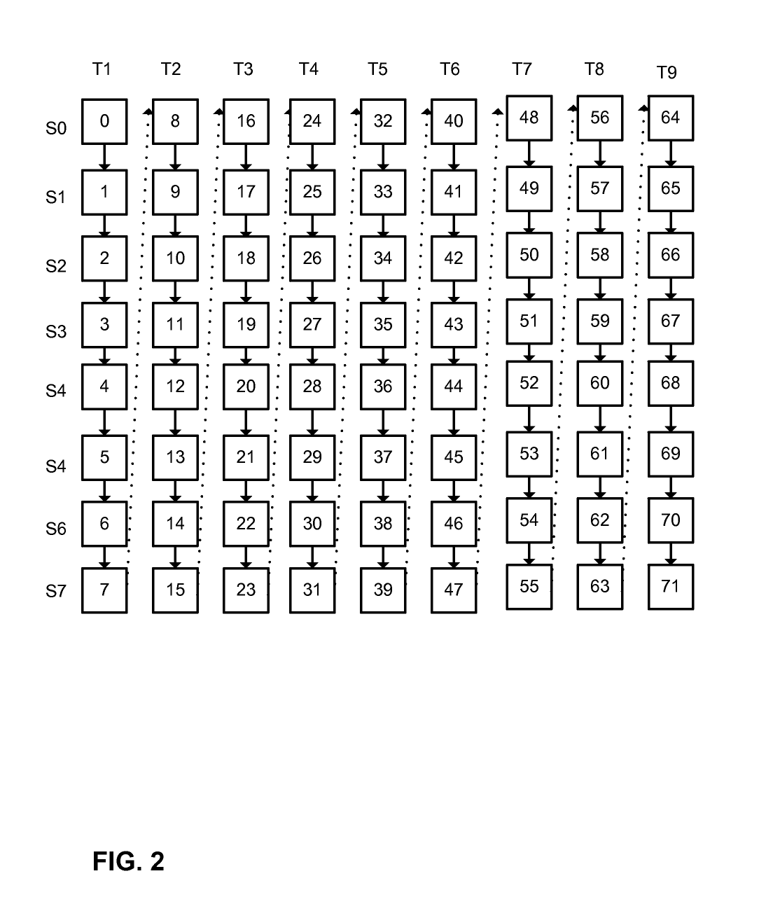

A typical MVC decoding order (i.e., bitstream order) is shown in FIG. 2. The decoding order arrangement is referred as time-first coding. Note that the decoding order of access units may not be identical to the output or display order. In FIG. 2, S0-S7 each refers to different views of the multiview video. T0-T8 each represents one output time instance. An access unit may include the coded pictures of all the views for one output time instance. For example, a first access unit may include all of the views S0-S7 for time instance T0, a second access unit may include all of the views S0-S7 for time instance T1, and so forth.

For purposes of brevity, the disclosure may use the following definitions:
view component: A coded representation of a view in a single access unit. When a view includes both coded texture and depth representations, a view component consists of a texture view component and a depth view component.
texture view component: A coded representation of the texture of a view in a single access unit.
depth view component: A coded representation of the depth of a view in a single access unit.

In FIG. 2, each of the views includes sets of pictures. For example, view S0 includes set of pictures 0, 8, 16, 24, 32, 40, 48, 56, and 64, view S1 includes set of pictures 1, 9, 17, 25, 33, 41, 49, 57, and 65, and so forth. Each set includes two pictures: one picture is referred to as a texture view component, and the other picture is referred to as a depth view component. The texture view component and the depth view component within a set of pictures of a view may be considered as corresponding to one another. For example, the texture view component within a set of pictures of a view is considered as corresponding to the depth view component within the set of the pictures of the view, and vice-versa (i.e., the depth view component corresponds to its texture view component in the set, and vice-versa). As used in this disclosure, a texture view component that corresponds to a depth view component may be considered as the texture view component and the depth view component being part of a same view of a single access unit.

The texture view component includes the actual image content that is displayed. For example, the texture view component may include luma (Y) and chroma (Cb and Cr) components. The depth view component may indicate relative depths of the pixels in its corresponding texture view component. As one example, the depth view component is a gray scale image that includes only luma values. In other words, the depth view component may not convey any image content, but rather provide a measure of the relative depths of the pixels in the texture view component.

For example, a purely white pixel in the depth view component indicates that its corresponding pixel or pixels in the corresponding texture view component is closer from the perspective of the viewer, and a purely black pixel in the depth view component indicates that its corresponding pixel or pixels in the corresponding texture view component is further away from the perspective of the viewer. The various shades of gray in between black and white indicate different depth levels. For instance, a very gray pixel in the depth view component indicates that its corresponding pixel in the texture view component is further away than a slightly gray pixel in the depth view component. Because only gray scale is needed to identify the depth of pixels, the depth view component need not include chroma components, as color values for the depth view component may not serve any purpose.

The depth view component using only luma values (e.g., intensity values) to identify depth is provided for illustration purposes and should not be considered limiting. In other examples, any technique may be utilized to indicate relative depths of the pixels in the texture view component.

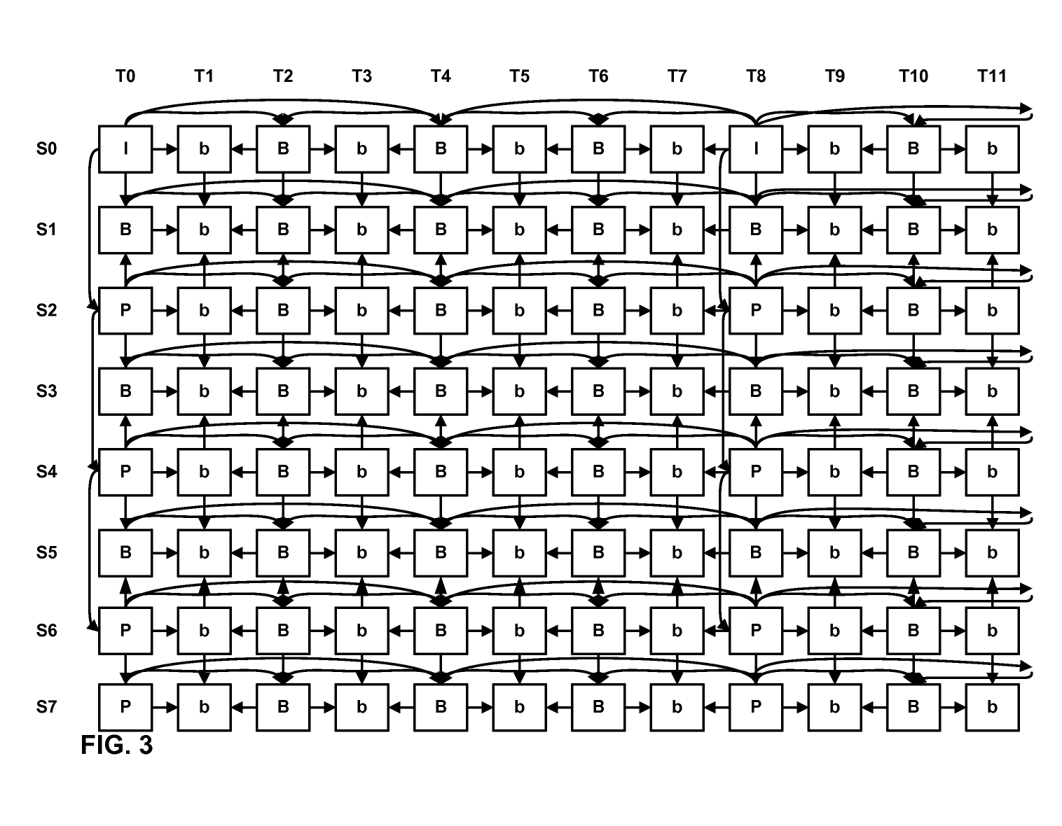

A typical MVC prediction structure (including both inter-picture prediction within each view and inter-view prediction) for multi-view video coding is shown in FIG. 3. Prediction directions are indicated by arrows, the pointed-to object using the pointed-from object as the prediction reference. In MVC, inter-view prediction is supported by disparity motion compensation, which uses the syntax of the H.264/AVC motion compensation, but allows a picture in a different view to be used as a reference picture.

In the example of FIG. 3, six views (having view IDs “S0” through “S5”) are illustrated, and twelve temporal locations (“T0” through “T11”) are illustrated for each view. That is, each row in FIG. 3 corresponds to a view, while each column indicates a temporal location.

Although MVC has a so-called base view, which is decodable by H.264/AVC decoders, and stereo view pairs could be supported also by MVC, the advantage of MVC is that it could support an example that uses more than two views as a 3D video input and decodes this 3D video represented by the multiple views. A renderer of a client having an MVC decoder may expect 3D video content with multiple views.

Pictures in FIG. 3 are indicated at the intersection of each row and each column. The H.264/AVC standard may use the term frame to represent a portion of the video. This disclosure may use the term picture and frame interchangeably.

The pictures in FIG. 3 are illustrated using a block including a letter, the letter designating whether the corresponding picture is intra-coded (that is, an I-picture), or inter-coded in one direction (that is, as a P-picture) or in multiple directions (that is, as a B-picture). In general, predictions are indicated by arrows, where the pointed-to pictures use the pointed-from picture for prediction reference. For example, the P-picture of view S2 at temporal location TO is predicted from the I-picture of view S0 at temporal location T0.

As with single view video encoding, pictures of a multiview video coding video sequence may be predictively encoded with respect to pictures at different temporal locations. For example, the b-picture of view S0 at temporal location T1 has an arrow pointed to it from the I-picture of view S0 at temporal location T0, indicating that the b-picture is predicted from the I-picture. Additionally, however, in the context of multiview video encoding, pictures may be inter-view predicted. That is, a view component can use the view components in other views for reference. In MVC, for example, inter-view prediction is realized as if the view component in another view is an inter-prediction reference. The potential inter-view references are signaled in the Sequence Parameter Set (SPS) MVC extension and can be modified by the reference picture list construction process, which enables flexible ordering of the inter-prediction or inter-view prediction references. Inter-view prediction is also a feature of proposed multiview extension of HEVC, including 3D-HEVC (multiview plus depth).

FIG. 3 provides various examples of inter-view prediction. Pictures of view S1, in the example of FIG. 3, are illustrated as being predicted from pictures at different temporal locations of view S1, as well as inter-view predicted from pictures of views S0 and S2 at the same temporal locations. For example, the b-picture of view S1 at temporal location T1 is predicted from each of the B-pictures of view S1 at temporal locations T0 and T2, as well as the b-pictures of views S0 and S2 at temporal location T1.

In some examples, FIG. 3 may be viewed as illustrating the texture view components. For example, the I-, P-, B-, and b-pictures illustrated in FIG. 2 may be considered as texture view components for each of the views. In accordance with the techniques described in this disclosure, for each of the texture view components illustrated in FIG. 3 there is a corresponding depth view component. In some examples, the depth view components may be predicted in a manner similar to that illustrated in FIG. 3 for the corresponding texture view components.

Coding of two views could also be supported also MVC. One of the advantages of MVC is that an MVC encoder could take more than two views as a 3D video input and an MVC decoder can decode such a multiview representation. As such, any renderer with an MVC decoder may expect 3D video contents with more than two views.

In MVC, inter-view prediction is allowed among pictures in the same access unit (i.e., with the same time instance). When coding a picture in one of the non-base views, a picture may be added into a reference picture list if it is in a different view, but within the same time instance. An inter-view reference picture can be put in any position of a reference picture list, just like any inter prediction reference picture. As shown in FIG. 3, a view component can use the view components in other views for reference. In MVC, inter-view prediction is realized as if the view component in another view was an inter-prediction reference.

The following describes some relevant HEVC techniques relating to inter-prediction that may be used with multiview coding and/or multiview coding (MV-HEVC) with depth (3D-HEVC). The first technique for discussion is reference picture list construction for inter-prediction.

Coding a PU using inter-prediction involves calculating a motion vector between a current block (e.g., PU) and a block in a reference frame. Motion vectors are calculated through a process called motion estimation (or motion search). A motion vector, for example, may indicate the displacement of a prediction unit in a current frame relative to a reference sample of a reference frame. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference frame or reference slice. In some examples, the reference sample may occur at a fractional pixel position. Upon finding a portion of the reference frame that best matches the current portion, the encoder determines the current motion vector for the current block as the difference in the location from the current block to the matching portion in the reference frame (e.g., from the center of the current block to the center of the matching portion).

In some examples, an encoder may signal the motion vector for each block in the encoded video bitstream. The signaled motion vector is used by the decoder to perform motion compensation in order to decode the video data. However, signaling the original motion vector directly may result in less efficient coding, as a large number of bits are typically needed to convey the information.

In some instances, rather than directly signaling the original motion vector, the encoder may predict a motion vector for each partition, i.e., for each PU. In performing this motion vector prediction, the encoder may select a set of motion vector candidates determined from spatially neighboring blocks in the same frame as the current block or a temporal motion vector candidate determined from a co-located block in a reference frame (i.e., a frame other than the current frame). Video encoder 20 may perform motion vector prediction, and if needed, signal an index to a reference picture to predict the motion vector, rather than signal an original motion vector, to reduce bit rate in signaling. The motion vector candidates from the spatially neighboring blocks may be referred to as spatial MVP candidates, whereas the motion vector candidates from co-located blocks in another reference frame may be referred to as temporal MVP candidates.

Two different modes or types of motion vector prediction are proposed in the HEVC standard. One mode is referred to as a “merge” mode. The other mode is referred to as adaptive motion vector prediction (AMVP).

In merge mode, video encoder 20 instructs video decoder 30, through bitstream signaling of prediction syntax, to copy a motion vector, reference index (identifying a reference frame, in a given reference picture list, to which the motion vector points) and the motion prediction direction (which identifies the reference picture list (List 0 or List 1), i.e., in terms of whether the reference frame temporally precedes or follows the currently frame) from a selected motion vector candidate for a current block of the frame. This is accomplished by signaling in the bitstream an index into a motion vector candidate list identifying the selected motion vector candidate (i.e., the particular spatial MVP candidate or temporal MVP candidate).

Thus, for merge mode, the prediction syntax may include a flag identifying the mode (in this case “merge” mode) and an index identifying the selected motion vector candidate. In some instances, the motion vector candidate will be in a causal block in reference to the current block. That is, the motion vector candidate will have already been decoded by video decoder 30. As such, video decoder 30 has already received and/or determined the motion vector, reference index, and motion prediction direction for the causal block. Accordingly, video decoder 30 may simply retrieve the motion vector, reference index, and motion prediction direction associated with the causal block from memory and copy these values as the motion information for the current block. To reconstruct a block in merge mode, video decoder 30 obtains the predictive block using the derived motion information for the current block, and adds the residual data to the predictive block to reconstruct the coded block.

Note, for the skip mode, the same merge candidate list is generated but no residual is signaled. For simplicity, since skip mode has the same motion vector derivation process as merge mode, all techniques described in this document apply to both merge and skip modes.

In AMVP, video encoder 20 instructs video decoder 30, through bitstream signaling, to only copy the motion vector from the candidate block and use the copied vector as a predictor for motion vector of the current block, and signals the motion vector difference (MVD). The reference frame and the prediction direction associated with the motion vector of the current block are signaled separately. An MVD is the difference between the current motion vector for the current block and a motion vector predictor derived from a candidate block. In this case, video encoder 20, using motion estimation, determines an actual motion vector for the block to be coded, and then determines the difference between the actual motion vector and the motion vector predictor as the MVD value. In this way, video decoder 30 does not use an exact copy of the motion vector candidate as the current motion vector, as in the merge mode, but may rather use a motion vector candidate that may be “close” in value to the current motion vector determined from motion estimation and add the MVD to reproduce the current motion vector. To reconstruct a block in AMVP mode, the decoder adds the corresponding residual data to reconstruct the coded block.

In most circumstances, the MVD requires fewer bits to signal than the entire current motion vector. As such, AMVP allows for more precise signaling of the current motion vector while maintaining coding efficiency over sending the whole motion vector. In contrast, the merge mode does not allow for the specification of an MVD, and as such, merge mode sacrifices accuracy of motion vector signaling for increased signaling efficiency (i.e., fewer bits). The prediction syntax for AMVP may include a flag for the mode (in this case AMVP flag), the index for the candidate block, the MVD between the current motion vector and the predictive motion vector from the candidate block, the reference index, and the motion prediction direction.

Inter-prediction may also include reference picture list construction. A reference picture list includes the reference pictures or reference frames that are available for performing motion search and motion estimation. Typically, reference picture list construction for the first or second reference picture list of a B picture (bi-directionally predicted picture) includes two steps: reference picture list initialization and reference picture list reordering (modification). Reference picture list initialization is an explicit mechanism that puts the reference pictures in the reference picture memory (also known as a decoded picture buffer (DPB)) into a list based on the order of POC (Picture Order Count, aligned with display order of a picture) values. The reference picture list reordering mechanism can modify the position of a picture that was put in the list during the reference picture list initialization step to any new position, or put any reference picture in the reference picture memory in any position even if the picture wasn't put in the initialized list. Some pictures, after the reference picture list reordering (modification), may be put in a position in the list that is very far from the initial position. However, if a position of a picture exceeds the number of active reference pictures of the list, the picture is not considered as an entry of the final reference picture list. The number of active reference pictures may be signaled in the slice header for each list. After reference picture lists are constructed (namely RefPicList0 and RefPicList1, if available), a reference index to a reference picture list can be used to identify any reference picture included in the reference picture list.

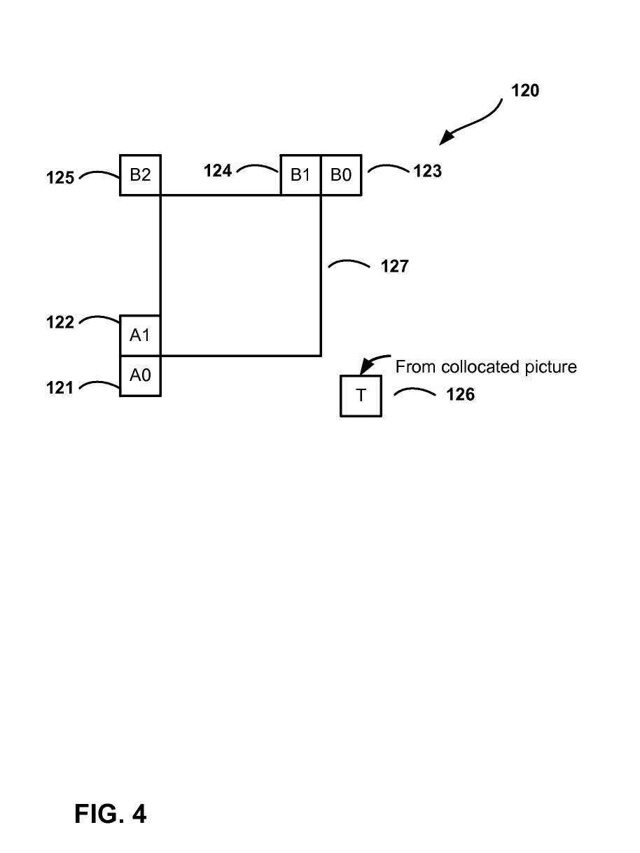

FIG. 4 shows an example set of candidate blocks 120 that may be used in both merge mode and AMVP mode. In this example, the candidate blocks are in the below left (A0) 121, left (A1) 122, left above (B2) 125, above (B1) 124, and right above (B0) 123 spatial positions, and in the temporal (T) 126 position(s). In this example, the left candidate block 122 is adjacent the left edge of the current block 127. The lower edge of the left block 122 is aligned with the lower edge of the current block 127. The above block 124 is adjacent the upper edge of the current block 127. The right edge of the above block 124 is aligned with the right edge of the current block 127.

The next technique for discussion relates to temporal motion vector predictors (TMVP) or temporal motion vector candidates. Temporal motion vector prediction only uses motion vector candidate blocks from frames other than the frame containing the currently coded CU. To get a TMVP, initially, a co-located picture is to be identified. In HEVC, the co-located picture is from a different time than the current picture for which the reference picture list is being constructed. If the current picture is a B slice, the syntax element collocated_from_{—}10_flag is signaled in a slice header to indicate whether the co-located picture is from RefPicList0 or RefPicList1. A slice header contains data elements that pertain to all video blocks contained within a slice. After a reference picture list is identified, the syntax element collocated_ref_idx signaled in slice header is used to identify the picture in the picture in the list.

A co-located prediction unit (PU) (e.g., a temporal motion vector candidate) is then identified by checking the co-located picture. Either the motion vector of the right-bottom PU of the coding unit (CU) containing this PU, or the motion of the right-bottom PU within the center PUs of the CU containing this PU is used.

When motion vectors identified by the above process are used to generate a motion candidate for advanced motion vector prediction (AMVP) or merge mode, they are typically scaled based on the temporal location (reflected by the POC). Note that the target reference index of all possible reference picture lists for the temporal merging candidate derived from TMVP is set to 0, while for AMVP, it is set equal to the decoded reference index.

In HEVC, the sequence parameter set (SPS) includes a flag sps_temporal_mvp_enable_flag and the slice header includes a flag pic_temporal_mvp_enable_flag when sps_temporal_mvp_enable_flag is equal to 1.

When both pic_temporal_mvp_enable_flag and temporal_id are equal to 0 for a particular picture, no motion vector from pictures before that particular picture in decoding order would be used as a temporal motion vector predictor in decoding of the particular picture or a picture after the particular picture in decoding order.

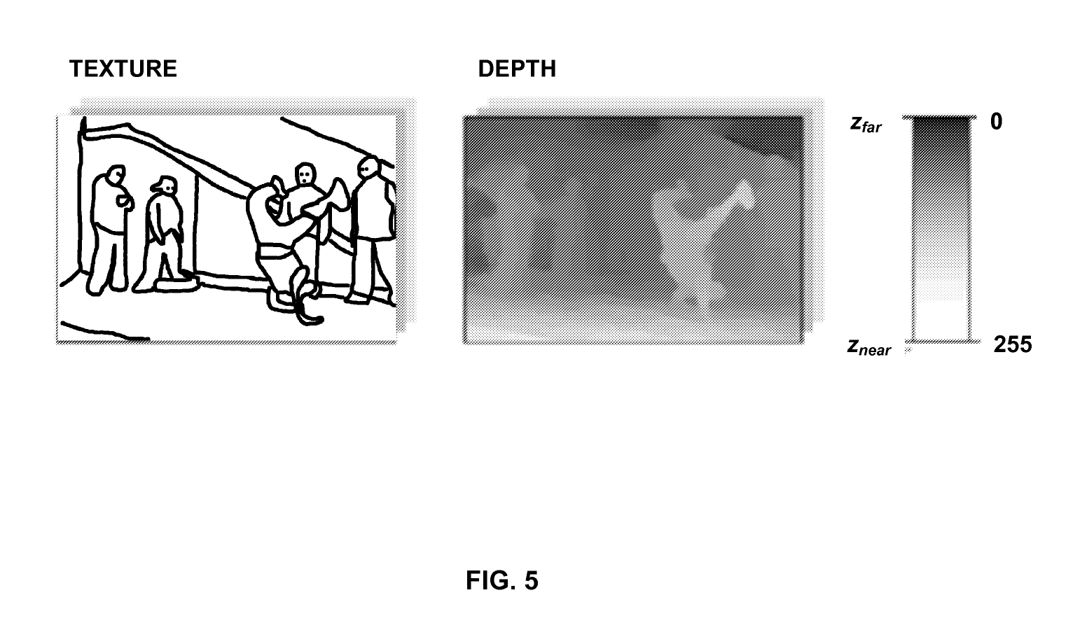

Another type of multiview video coding format introduces the use of depth values. For the multiview-video-plus-depth (MVD) data format, which is popular for 3D television and free viewpoint videos, texture images and depth maps can be coded with multiview texture pictures independently. FIG. 5 illustrates the MVD data format with a texture image and its associated per-sample depth map. The depth range may be restricted to be in the range of minimum zₙₑₐᵣ and maximum z_{far} distance from the camera for the corresponding 3D points.

Camera parameters and depth range values may be helpful for processing decoded view components prior to rendering on a 3D display. Therefore, a special supplemental enhancement information (SEI) message is defined for the current version of H.264/MVC, i.e., multiview acquisition information SEI, which includes information that specifies various parameters of the acquisition environment. However, there are no syntaxes specified in H.264/MVC for indicating the depth range related information. 3D video (3 DV) may be represented using the Multiview Video plus Depth (MVD) format, in which a small number of captured texture images of various views (which may correspond to individual horizontal camera positions), as well as associated depth maps, may be coded and the resulting bitstream packets may be multiplexed into a 3D video bitstream. Currently, a Joint Collaboration Team on 3D Video Coding (JCT-3C) of VCEG and MPEG is developing a 3 DV standard based on HEVC, for which part of the standardization efforts includes the standardization of the multiview video codec based on HEVC (MV-HEVC) and another part for 3D Video coding based on HEVC (3D-HEVC). For MV-HEVC, it should be guaranteed that there are only high-level syntax (HLS) changes in it, such that no module in the CU/PU level in HEVC needs to be re-designed and can be fully reused for MV-HEVC. For 3D-HEVC, new coding tools, including those in coding unit/prediction unit level, for both texture and depth views may be included and supported. The latest software 3D-HTM for 3D-HEVC can be downloaded from the following link:

https://hevc.hhi.fraunhofer.de/svn/svn 3DVCSoftware/tags/HTM-4.0.1/

To further improve the coding efficiency, two new technologies namely “inter-view motion prediction” and “inter-view residual prediction” have been adopted in the latest reference software. Inter-view motion prediction and inter-view residual prediction utilize motion vector candidates or residuals and CUs in different views from the currently coded view. The views used for motion search, motion estimation, and motion vector prediction may be from the same time instance as the currently coded view or may be from a different time instance. To enable these two coding tools, the first step is to derive a disparity vector.

Similarly to MVC, in 3D-HEVC, inter-view prediction based on the reconstructed view components from different views is enabled. In this case, the type of the reference picture that a TMVP in the co-located picture points to, and that of the target reference picture for the temporal merging candidate (with an index equal to 0 in HEVC) may be different. For example, one reference picture is an inter-view reference picture (type set to disparity) and the other reference picture is a temporal reference picture (type set to temporal). An inter-view reference picture may be a reference picture from another view from the current view being coded. This inter-view reference picture may be from the same time instance (e.g., the same POC) or from a different time reference. A temporal reference picture is a picture from a different time instance as the currently coded CU, but in the same view. In other examples, such as in the current 3D-HTM software, the target reference picture for the temporal merging candidate can be set to 0 or equal to the value of the reference picture index of the left neighboring PU relative to the currently coded PU. Therefore, the target reference picture index for the temporal merging candidate may not be equal to 0.

To derive a disparity vector, a method called Neighboring Blocks based Disparity Vector (NBDV) derivation is used in the current 3D-HTM. NBDV derivation utilizes disparity motion vectors from spatial and temporal neighboring blocks. In NBDV derivation, the motion vectors of spatial or temporal neighboring blocks are checked in a fixed checking order. Once a disparity motion vector is identified, i.e., the motion vector points to an inter-view reference picture, the checking process is terminated and the identified disparity motion vector is returned and converted to a disparity vector which will be used in inter-view motion prediction and inter-view residual prediction. A disparity vector is a displacement between two views, while a disparity motion vector is a kind of motion vector, similar to the temporal motion vector used in 2D video coding, which is used for motion compensation when the reference picture is from a different view. If no disparity motion vector is found after checking all the pre-defined neighboring blocks, a zero disparity vector will be used for inter-view motion prediction, while inter-view residual prediction will be disabled for the corresponding PU.

The spatial and temporal neighboring blocks used for NBDV are described in the following section, followed by the checking order. Five spatial neighboring blocks are used for disparity vector derivation. They are the same blocks as shown in FIG. 4.

All the reference pictures from the current view are treated as candidate pictures. In some examples, the number of candidate pictures can be constrained to a specific number, e.g., 4, as in the current 3D-HTM software implementation. Co-located reference pictures are checked first and the rest of candidate pictures are checked in the ascending order of reference index (refldx). When both Reference Picture List 0 and Reference Picture List 1 are available, the first reference picture list checked is determined by the collocated_from_{—}10_flag. The collocated_from_{—}10_flag equal to 1 specifies the picture that contains the collocated partition is derived from Reference Picture List 0, otherwise the picture is derived from Reference Picture List 1. When collocated_from_{—}10_flag is not present, it is inferred to be equal to 1.

For each candidate picture, three candidate regions are determined for deriving the temporal neighboring blocks. When a region covers more than one 16×16 block, all 16×16 blocks in such a region are checked in raster scan order. The three candidate regions are defined as follows:
CPU: Co-located PU. The co-located region of the current PU or current CU.
CLCU: Co-located largest coding unit. The largest coding unit (LCU) covering the co-located region of the current PU
BR: Bottom-right (BR) 4×4 block of CPU.

The checking order for candidate blocks may be defined as follows. Spatial neighboring blocks are checked first, followed by temporal neighboring blocks. The checking order of the five spatial neighboring blocks, with reference to FIG. 4, may be defined as A1, B1, B0, A0 and B2.

For each candidate picture, the three candidate regions in this candidate picture will be checked in order. The checking order of the three regions is defined as: CPU, CLCU and BR for the first non-base view or BR, CPU, CLU for the second non-base view.

Based on the disparity vector (DV), a new motion vector candidate (i.e., the inter-view predicted motion vector), if available, may be added to AMVP and skip/merge mode candidate lists. The inter-view predicted motion vector, if available, is a temporal motion vector.

Since skip mode has the same motion vector derivation process as merge mode, all techniques described in this document apply to both merge and skip modes. For the merge/skip mode, the inter-view predicted motion vector is derived by the following steps:

(1) A corresponding block of the current PU/CU in a reference view of the same access unit is located by the disparity vector.
(2) If the corresponding block is not intra-coded and not inter-view predicted, and its reference picture has a POC value equal to that of one entry in the same reference picture list of current PU/CU, its motion information (prediction direction, reference pictures, and motion vectors), after converting the reference index based on the POC, is derived to be the inter-view predicted motion vector.

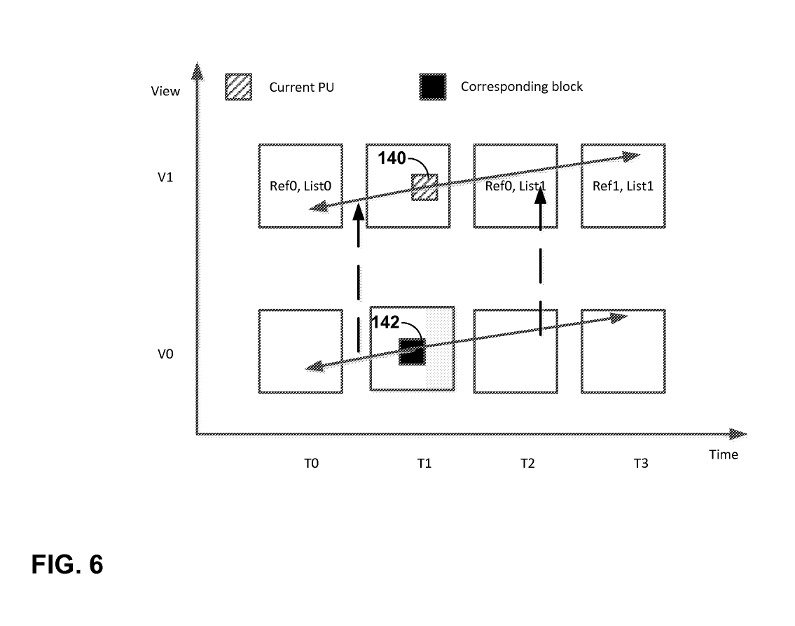

FIG. 6 shows an example of the derivation process of the inter-view predicted motion vector candidate. A disparity vector is calculated by finding corresponding block 142 in a different view (e.g., view 0 or V0) to current PU 140 in the currently coded view (view 1 or V1). If corresponding block 142 is not intra-coded and not inter-view predicted, and its reference picture has a POC value that is in the reference picture list of current PU 140 (e.g., Ref0, List0; Ref0, List1; Ref1, List 1, as shown in FIG. 6), then the motion information for corresponding block 142 is used as an inter-view predicted motion vector. As stated above, the reference index may be scaled based on the POC.

If the inter-view predicted motion vector is not available (e.g., corresponding block 142 is intra-coded or inter-view predicted), the disparity vector is converted to an inter-view disparity motion vector, which is added into the AMVP or merge candidate list in the same position as an inter-view predicted motion vector when it is available. Either the inter-view predicted motion vector or the inter-view disparity motion vector may be called an “inter-view candidate” in this context.

In AMVP mode, if the target reference index corresponds to a temporal motion vector, the inter-view predicted motion vector is found by checking the motion vectors in the corresponding block of the current PU located by the disparity vector. Also, in AMVP mode, if the target reference index corresponds to a disparity motion vector, the inter-view predicted motion vector will not be derived, and the disparity vector is converted to an inter-view disparity motion vector.

In the merge/skip mode, the inter-view predicted motion vector, if available, is inserted in the merge candidate list before all spatial and temporal merging candidates. If an inter-view predicted motion vector is not available, an inter-view disparity motion vector, if available, is inserted in the same position. In the current 3D-HTM software, the inter-view predicted motion vector or inter-view disparity motion vector follows after all the valid spatial candidates in the AMVP candidate list if it is different from all the spatial candidates.

The current design of motion related coding in HEVC based multiview/3 DV coding has the following problems due to the fact that the derived disparity vector often lacks accuracy, thus resulting in lower coding efficiency.

One drawback is that the disparity vector derived from the first available disparity motion vector is chosen while another disparity motion vector of other spatial/temporal neighboring blocks may be more accurate. Another drawback is that inaccurate disparity vectors may lead to inaccurate inter-view predicted motion vectors. Another drawback results when multiple motion vector candidates are added into the merge candidate list. In this case, there may be redundant (i.e., identical) motion vector candidates.

Another drawback results when a disparity vector is converted to an inter-view disparity motion vector to be added into the merge list. If the inter-view disparity vector is not accurate, the inter-view disparity motion vector may be inaccurate.

Still another drawback results when the spatial/temporal neighboring blocks are used to derive the merging candidates and they are inter-view predicted. In this case, the vertical component of the motion vector may be not equal to 0.

In view of these drawbacks, this disclosure proposes various methods and techniques for further improving disparity vector accuracy, as well as the accuracy of inter-view predicted motion vectors and inter-view disparity motion vectors.

In a first example of the disclosure, video encoder 20 and video decoder 30 may be configured to derive multiple disparity vectors from neighboring blocks, thus providing more disparity vectors for selection for inter-view motion prediction and/or inter-view residual prediction. That is, rather than just deriving a disparity vector for the currently coded PU, more disparity vectors are also derived for the current block.

In one example, instead of returning the first identified disparity motion vector of neighbouring blocks in the NBDV process, multiple identified disparity motion vectors may be returned. Deriving additional disparity vectors increases the likelihood that a more accurate disparity vector is chosen. In a further aspect of this example, when multiple disparity motion vectors are derived, an index may be signaled for a PU or CU to indicate which of the multiple disparity vectors is used for inter-view motion prediction and/or inter-view residual prediction. A fixed number of the disparity vectors may be specified at video decoder 30. In another example, the above technique may be only applied to one of AMVP or merge mode. In another example, the above techniques are applied to both AMP and merge mode.

In another example of the disclosure, when multiple disparity motion vectors are derived, the multiple disparity vectors can be used to convert more inter-view predicted motion vector candidates and/or inter-view disparity motion vectors to be added into the merge and/or AMVP candidate list. In one example, the additional disparity vectors (e.g., from neighboring blocks, as described above) are all converted to inter-view disparity motion vectors. The first disparity vector is used in the same manner as the current disparity vector. In another example, each of the additional disparity vectors is converted to an inter-view predicted motion vector candidate initially, and if that is unavailable (e.g., if the corresponding block in intra-coded or inter-view predicted), the disparity vector is converted to an inter-view disparity motion vector. The first disparity vector is used in the same manner as the current disparity vector.

In another example of the disclosure, even when just one disparity vector is derived from a neighboring block, more than one inter-view predicted motion vector candidates and/or disparity motion vectors can be added into the merge and/or AMVP candidate list. In one alternative of this example, after the reference block of the base view is identified by the disparity vector, the left PU and/or the right PU of the PU containing the disparity vector pointing to the reference block are used to generate inter-view predicted motion vector candidates in the same manner that the inter-view predicted motion vector candidate was generated from the reference block. In another alternative of this example, after the inter-view predicted motion vector candidate is derived, the motion vector is shifted horizontally by 4 and/or −4 (i.e., corresponding to one pixel) for each motion vector corresponding to either reference picture list 0 or reference picture list 1. In another alternative of this example, disparity motion vectors shifted from the disparity motion vector converted by the disparity vector are included in the merge and/or AMVP candidate list. In one alternative example, the shifted value is 4 and/or −4 horizontally. In another alternative example, the shifted value is equal to w and/or −w, wherein w is the width of the PU containing reference block. In another alternative example, the shifted value is equal to w and/or −w, wherein w is the width of the current PU.

In another example of the disclosure, when just one disparity vector is derived from a neighboring block, and even after an inter-view predicted motion vector candidate is added, the disparity vector can be converted to an inter-view disparity motion vector and further added into the merge and/or AMVP candidate list. In previous techniques for merge/AMVP candidate list construction, inter-view disparity motion vector candidates were not included in the candidate list.

In another example of the disclosure, the MERGE and/or AMVP candidates added by any of the above methods are inserted in to the respective candidate list in one of the following certain positions for a given picture type (or regardless of the picture type). In one example, the candidate is inserted after the inter-view predicted motion vector candidate or inter-view disparity motion vector candidate derived by the first disparity vector, thus before all spatial candidates. In another example, the candidate is inserted after all spatial and temporal candidates, and the candidate derived by the first disparity vector, thus before the combined candidates. In another example, the candidate is inserted after all the spatial candidates, but before the temporal candidate. In another example, the candidate is inserted before all candidates.

In another example of the disclosure, pruning may be applied for each of the newly added motion vector candidates, even including the candidate derived from the first disparity vector. Pruning involves removing a candidate from the motion vector candidate list if it is redundant (e.g., identical to another candidate). The comparison made for pruning may be among all candidates, or between the newly added candidate based on the disparity vector and another type of candidate (e.g., spatial candidate, temporal candidate, etc.). In one alternative of this example, only selective spatial candidates (e.g., A1, B1) are compared to the newly derived motion vector candidates for pruning, including the candidate derived from the first disparity vector. In addition, the newly added motion vector candidate, including the one derived from the first disparity vector, is compared with each other to avoid duplications.

In another example of the disclosure, when the motion information from spatial/temporal neighboring blocks is used to derive the motion vector candidates, and the motion vector is a disparity motion vector, the vertical component of motion vector may be forced to be set to 0 for merge and/or AMVP mode.

In the following section, an example implementation of some of the proposed techniques is described. In this example implementation, only up to 1 unequal disparity vectors may be derived. The first disparity vector is used in a similar way as the current disparity vector. The second disparity vector is converted to an inter-view disparity motion vector.

The derivation of multiple disparity vectors is similar to NBDV and has the same checking order of the neighboring blocks. After video encoder 20 and/or video decoder 30 identifies the first disparity motion vector, the checking process continues until one new unequal disparity motion vector is found (i.e., a disparity vector with a different value than the first disparity vector). When the number of new disparity motion vectors found exceeds a certain value N, even when a new unequal disparity vector is not found, no additional disparity motion vectors are derived. N may be an integer value larger than 1, for example, 10.

In one alternative implementation, if the second available disparity motion vector (preceding the unequal disparity vector in the checking order) is equal to the first disparity motion vector, video encoder 20 sets a flag (namely dupFlag) to 1; otherwise it is set to 0.

The process to derive the first motion vector candidate from the first disparity vector is the same as in the current 3D-HEVC. However, the second disparity vector is converted to an inter-view disparity motion vector (second new candidate) and added into the candidate list right after the first candidate derived from the first disparity vector, thus before all the spatial candidates.

In another example, if dupFlag is equal to 0, the second disparity vector is converted to an inter-view disparity motion vector (second new candidate) and added into the candidate list right after the first candidate derived from the first disparity vector, thus before all the spatial candidates. If dupFlag is equal to 1, the following applies:
If the first candidate is an inter-view predicted motion vector candidate, the first disparity vector is converted to be the second candidate, which is an inter-view disparity motion vector.
Otherwise, the second disparity vector is converted to be the second candidate, which is an inter-view disparity motion vector.

Insertion of the additional motion vector candidates into the motion vector candidate list may be accomplished as follows. Both the first candidate and the second candidate are compared with the spatial candidates derived from A1 and B1 (see FIG. 4). If the spatial candidate from A1 or B1 is equal to either of these two new candidates, the spatial candidate is removed from the candidate list. Alternatively, the two new candidates based on disparity vectors are both compared with the first two spatial candidates in the candidate list.

In another example of the disclosure, only one disparity vector may be derived. However, more candidates may be derived based on the disparity vector for skip/merge modes.

Conversion of the first disparity vector may be accomplished as follows. Based on the disparity vector, an inter-view predicted motion vector (i.e., 1^{st} inter-view candidate, or 1^{st} IVC), if available, is added to skip/merge modes candidate list. The generation process of the 1^{st} IVC may be the same as current 3D-HEVC design. In addition, the disparity vector is converted into an inter-view disparity motion vector (sometimes called a 2^{nd} IVC) and further added into the candidate list after the 1^{st} inter-view candidate, if applicable, and before all the spatial candidates.

Inter-view candidates from neighboring PUs may be treated as follows. After the reference block of the base view is identified by the disparity vector, the left PU of the PU containing the reference block is used to generate an inter-view predicted motion vector candidate in a similar fashion to the inter-view predicted motion vector candidate generation techniques in the current 3D-HEVC specification. Furthermore, according to the techniques of this disclosure, if the inter-view predicted motion vector candidate is unavailable, an inter-view disparity motion vector candidate is derived with the disparity vector subtracted by the width of the left PU in the horizontal component. Either the inter-view predicted motion vector candidate or the inter-view disparity motion vector derived from left PU (i.e., Inter-View Candidate from Left PU, or IVCLPU) is inserted to the candidate list after all the spatial candidates. This additional candidate is inserted before the temporal candidate.

Furthermore, the right PU of the PU containing the reference block may be used to generate inter-view predicted motion vector candidates similar to the inter-view predicted motion vector candidate generation process in current 3D-HEVC specification. Furthermore, according to the techniques of this disclosure, if the inter-view predicted motion vector candidate is not available, an inter-view disparity motion vector candidate is derived with the disparity vector added by the width of the PU containing the reference block in the horizontal component. Either the inter-view predicted motion vector candidate or the inter-view disparity motion vector derived from right PU (i.e., the Inter-View Candidate from Left PU, or IVCRPU) is inserted to the merge candidate list after all the spatial merging candidates and the inter-view candidate derived from left PU. This additional candidate is inserted before the temporal candidate and after the IVCLPU.

In another example, both of the two newly added inter-view candidates (i.e., the IVCLPU and the IVCRPU), if available are inserted to the candidate list after the temporal candidate. In another example, only one of the IVCLPU and the IVCRPU is added into the candidate list.

An additional pruning process based on inter-view candidates may be accomplished as follows. Each spatial candidate derived from A1 or B1 is compared to the 1st IVC and 2nd IVC, if available, respectively. If the spatial candidate from Al or B1 is equal to either of these two candidates, it is removed from the merge candidate list. In addition, the IVCLPU may be compared to the 1st IVC, 2nd IVC, and the spatial candidates derived from A1 or B1, respectively. If the IVCLPU is equal to any of these candidates, it is removed from the candidate list. Furthermore, the IVCRPU may be compared to the 1st IVC, 2nd IVC, the spatial candidates derived from A1 or B1, and the IVCLPU, respectively. If the IVCRPU is equal to any of these candidates, it is removed from the candidate list.

In another example of pruning according to this disclosure, only when two candidates have the same type (e.g., they are disparity motion vectors or they are temporal motion vectors) are they compared. For example, if the IVCLPU is an inter-view predicted motion vector, the comparison between the IVCLPU and 1st IVC is not needed.

In another example of this disclosure, only up to 1 unequal disparity vectors may be derived. The first disparity vector is used to derive the 1st IVC, the 2nd IVC, the IVCLPU and the IVCRPU using the techniques described above. The second disparity vector is converted to an inter-view disparity motion vector. Derivation of multiple disparity vectors may be accomplished according to the techniques described above. The same techniques described above for converting the first disparity vector and deriving more inter-view candidates from left and right PUs may be utilized.

Conversion of the second disparity vector may be accomplished as follows. The second disparity vector may be converted to an inter-view disparity motion vector (i.e., 3rd IVC) and added into the candidate list, right after the 1st IVC and the 2nd IVC, if available, and thus before all the spatial candidates. An additional pruning process based on inter-view candidates may be performed as follows. Each spatial candidate derived from A1 or B1 is compared to the 1st IVC, 2nd IVC, and 3rd IVC, if available, respectively. If the spatial candidate from A1 or B1 is equal to any of these three candidates, it is removed from the candidate list.

In one example, the IVCLPU is compared to the 1st IVC, the 2nd IVC, the 3rd IVC, and the spatial candidates derived from A1 or B1, respectively. If the IVCLPU is equal to any of these candidates, it is removed from the candidate list.

In another example, the IVCRPU is compared to the 1st IVC, the 2nd IVC, the 3rd IVC, the spatial candidates derived from A1 or B1, and the IVCLPU, respectively. If the IVCRPU is equal to any of these candidates, it is removed from the candidate list.

In another example of pruning according to this disclosure, only when two candidates have the same type (e.g., they are disparity motion vectors or they are temporal motion vectors) are they compared. For example, if the IVCLPU is an inter-view predicted motion vector the comparison between the IVCLPU and 1st IVC is not needed.

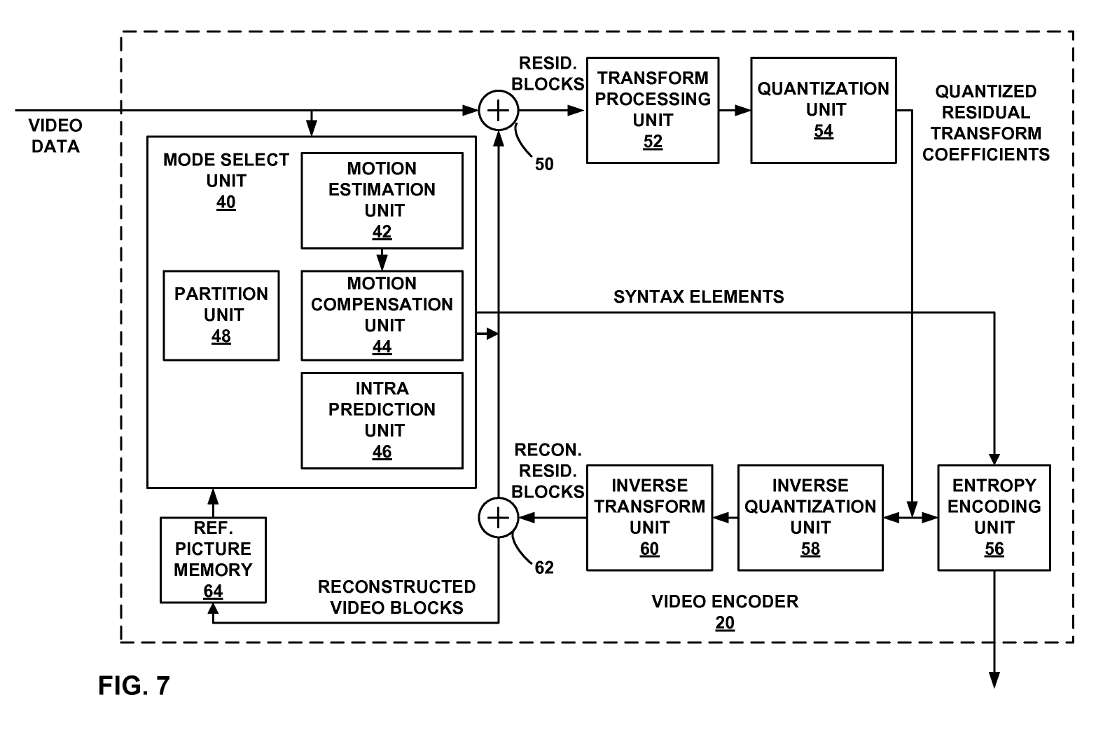

FIG. 7 is a block diagram illustrating an example of video encoder 20 that may implement the techniques of this disclosure. Video encoder 20 may perform intra- and inter-coding (including inter-view coding) of video blocks within video slices, e.g., slices of both texture images and depth maps. Texture information generally includes luminance (brightness or intensity) and chrominance (color, e.g., red hues and blue hues) information. In general, video encoder 20 may determine coding modes relative to luminance slices, and reuse prediction information from coding the luminance information to encode chrominance information (e.g., by reusing partitioning information, intra-prediction mode selections, motion vectors, or the like). Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 7, video encoder 20 receives a current video block (that is, a block of video data, such as a luminance block, a chrominance block, or a depth block) within a video frame (e.g., a texture image or a depth map) to be encoded. In the example of FIG. 7, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 7) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit).

A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame picture 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame picture 64. The reference picture lists may be constructed using the techniques of this disclosure. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. In this manner, motion compensation unit 44 may reuse motion information determined for luma components to code chroma components such that motion estimation unit 42 need not perform a motion search for the chroma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients.

The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame picture 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame picture 64. The reconstructed video block may be used by motion estimation unit 42 and motion compensation unit 44 as a reference block to inter-code a block in a subsequent video frame.

Video encoder 20 may encode depth maps in a manner that substantially resembles coding techniques for coding luminance components, albeit without corresponding chrominance components. For example, intra-prediction unit 46 may intra-predict blocks of depth maps, while motion estimation unit 42 and motion compensation unit 44 may inter-predict blocks of depth maps. However, as discussed above, during inter-prediction of depth maps, motion compensation unit 44 may scale (that is, adjust) values of reference depth maps based on differences in depth ranges and precision values for the depth ranges. For example, if different maximum depth values in the current depth map and a reference depth map correspond to the same real-world depth, video encoder 20 may scale the maximum depth value of the reference depth map to be equal to the maximum depth value in the current depth map, for purposes of prediction. Additionally or alternatively, video encoder 20 may use the updated depth range values and precision values to generate a view synthesis picture for view synthesis prediction, e.g., using techniques substantially similar to inter-view prediction.

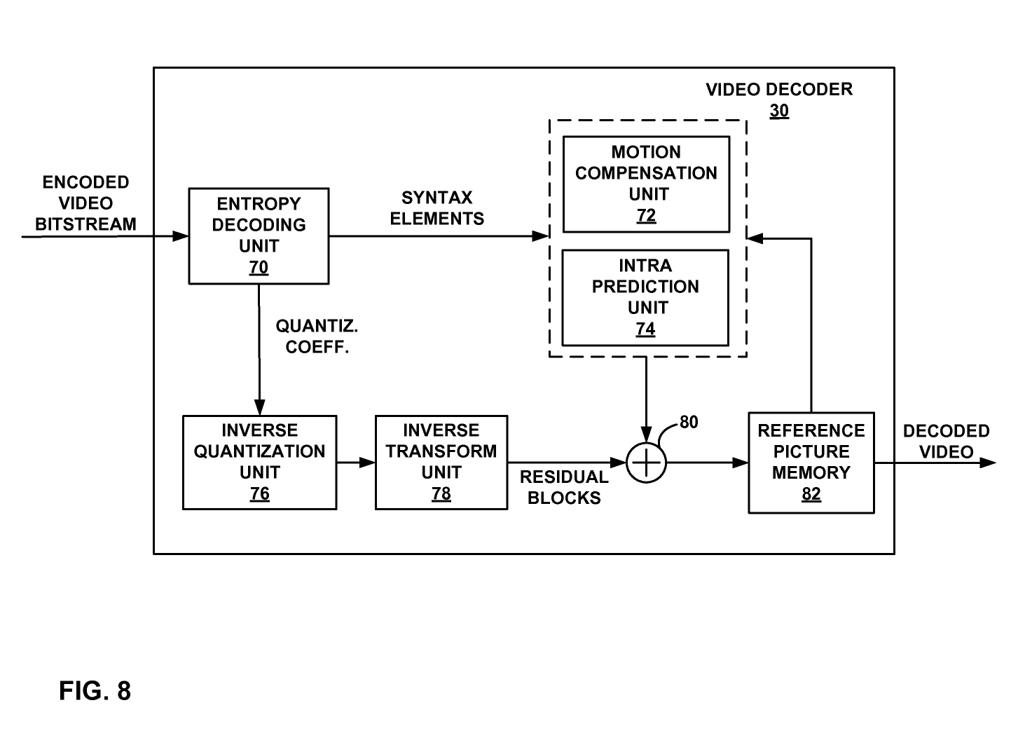

FIG. 8 is a block diagram illustrating an example of video decoder 30 that may implement the techniques of this disclosure. In the example of FIG. 8, video decoder 30 includes an entropy decoding unit 70, motion compensation unit 72, intra prediction unit 74, inverse quantization unit 76, inverse transformation unit 78, reference frame picture 82 and summer 80. Video decoder 30 may, in some examples, perform a decoding pass generally reciprocal to the encoding pass described with respect to video encoder 20 (FIG. 7). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using the techniques of this disclosure based on reference pictures stored in reference frame picture 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

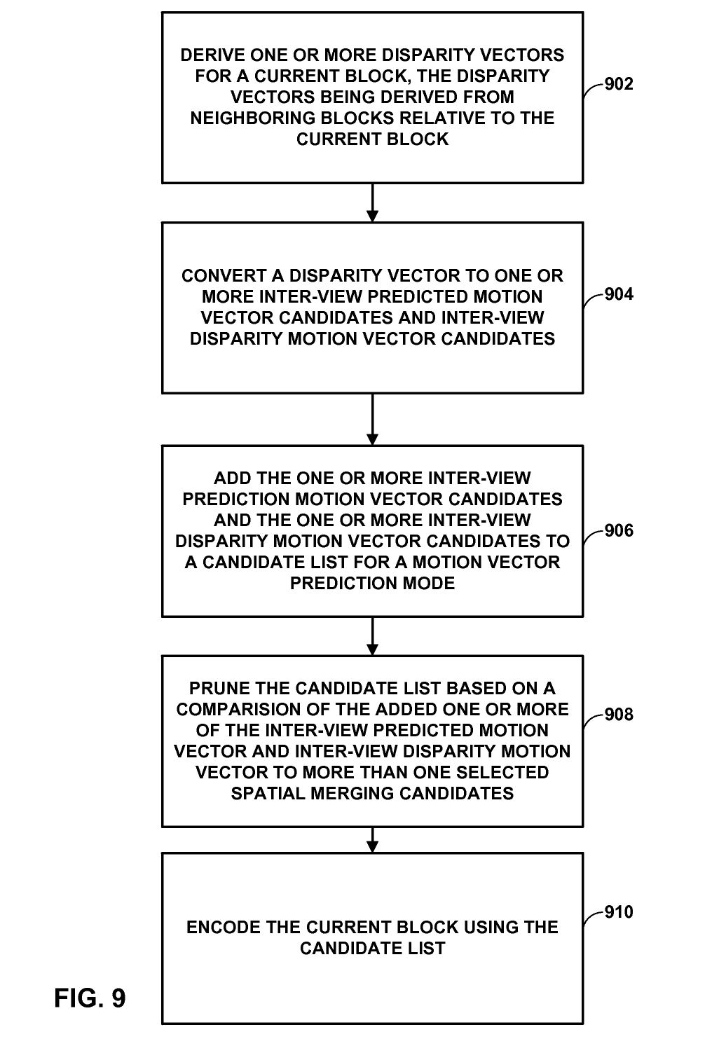

FIG. 9 is a flowchart showing an example encoding process according to the techniques of the disclosure. The techniques of FIG. 9 may be implemented by one or more structural units of video encoder 20. Video encoder 20 may be configured to derive one or more disparity vectors for a current block, the disparity vectors being derived from neighboring blocks relative to the current block (902), and to convert a disparity vector to one or more inter-view predicted motion vector candidates and inter-view disparity motion vector candidates (904).

Video encoder 20 may be further configured to add the one or more inter-view predicted motion vector candidates and the one or more inter-view disparity motion vector candidates to a candidate list for a motion vector prediction mode (906). The motion vector prediction mode may be one of a skip mode, a merge mode, and an AMVP mode. In one example of the disclosure, video encoder 20 may be configured to prune candidate list based on a comparison of the added one or more of the inter-view predicted motion vector and inter-view disparity motion vector to more than one selected spatial merging candidates (908). Video encoder 20 may further be configured to encode the current block using the candidate list (910). In one example of the disclosure, video encoder 20 may be configured to encode the current block using one of inter-view motion prediction and inter-view residual prediction.

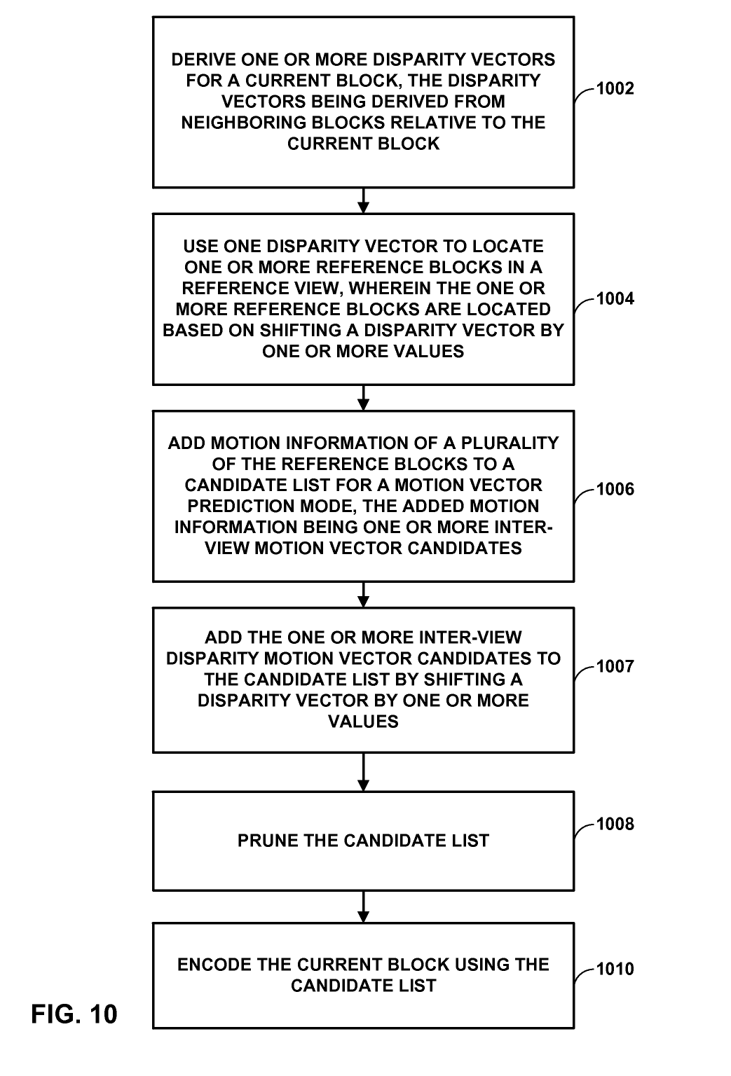

FIG. 10 is a flowchart showing an example encoding process according to the techniques of the disclosure. The techniques of FIG. 10 may be implemented by one or more structural units of video encoder 20. Video encoder 20 may be configured to derive one or more disparity vectors for a current block, the disparity vectors being derived from neighboring blocks relative to the current block (1002), and one disparity vector to locate one or more reference blocks in a reference view, wherein the one or more reference blocks are located based on shifting a disparity vector by one or more values (1004).

Video encoder 20 may be further configured to add motion information of a plurality of the reference blocks to a candidate list for a motion vector prediction mode, the added motion information being one or more inter-view motion vector candidates (1006). Video encoder 20 may be further configured to add the one or more inter-view disparity motion vector candidates to the candidate list by shifting a disparity vector by one or more values (1007). In some examples of the disclosure, video encoder 20 may be further configured to prune the candidate list (1008). In one example of the disclosure, pruning the candidate list is based on a comparison of the one or more added inter-view motion vector candidates to spatial merging candidates. In another example of the disclosure, pruning the candidate list is based on a comparison of the one or more added inter-view motion vector candidates, without shifting, to inter-view motion vector candidates based on a shifted disparity vector.

In one example of the disclosure, video encoder 20 may be further configured to shift the one or more disparity vectors by a value from −4 to 4 horizontally, such that the shifted disparity vectors are fixed within a slice. In another example of the disclosure, video encoder 20 may be further configured to shift the one or more disparity vectors by a value based on a width of a prediction unit (PU) containing a reference block. In another example of the disclosure, video encoder 20 may be further configured to shift the one or more disparity vectors by a value based on a width of the current block.

Video encoder 20 may be further configured to encode the current block using the candidate list (1110). In one example of the disclosure, encoding the current block comprises one of encoding the current block using inter-view motion prediction and/or encoding the current block using inter-view residual prediction.

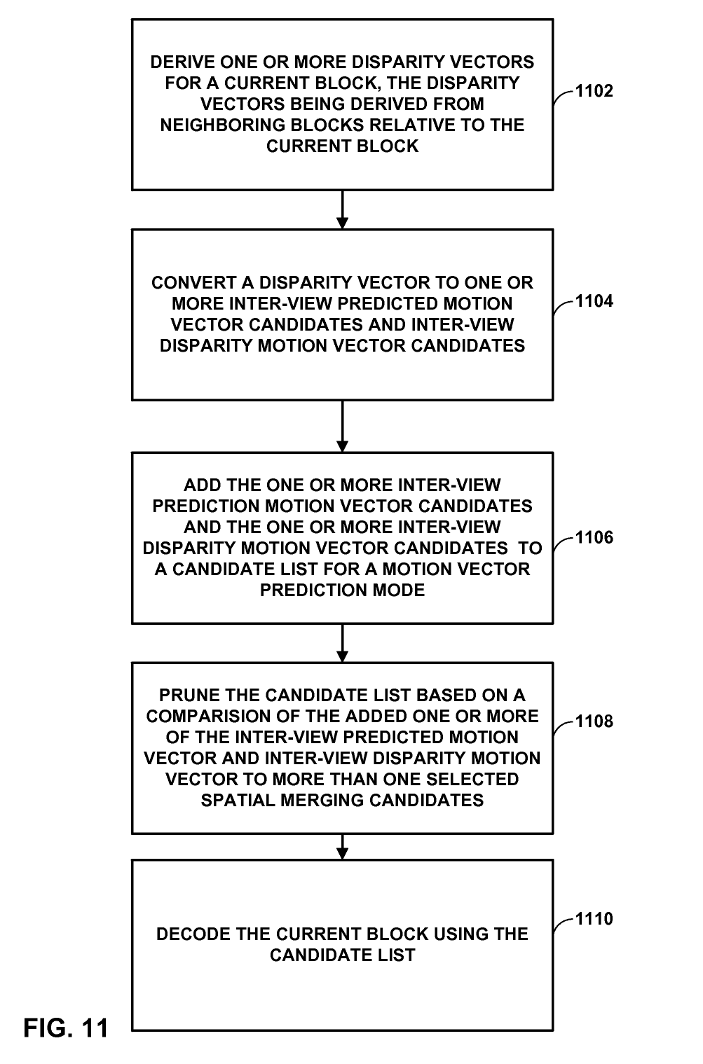

FIG. 11 is a flowchart showing an example decoding process according to the techniques of the disclosure. The techniques of FIG. 11 may be implemented by one or more structural units of video decoder 30. Video decoder 30 may be configured to derive one or more disparity vectors for a current block, the disparity vectors being derived from neighboring blocks relative to the current block (1102), and to convert a disparity vector to one or more inter-view predicted motion vector candidates and inter-view disparity motion vector candidates (1104).

Video decoder 30 may be further configured to add the one or more inter-view predicted motion vector candidates and the one or more inter-view disparity motion vector candidates to a candidate list for a motion vector prediction mode (1106). The motion vector prediction mode may be one of a skip mode, a merge mode, and an AMVP mode. In one example of the disclosure, video decoder 30 may be configured to prune candidate list based on a comparison of the added one or more of the inter-view predicted motion vector and inter-view disparity motion vector to more than one selected spatial merging candidates (1108). Video decoder 30 may further be configured to decode the current block using the candidate list (1110). In one example of the disclosure, video decoder 30 may be configured to decode the current block using one of inter-view motion prediction and/or inter-view residual prediction.

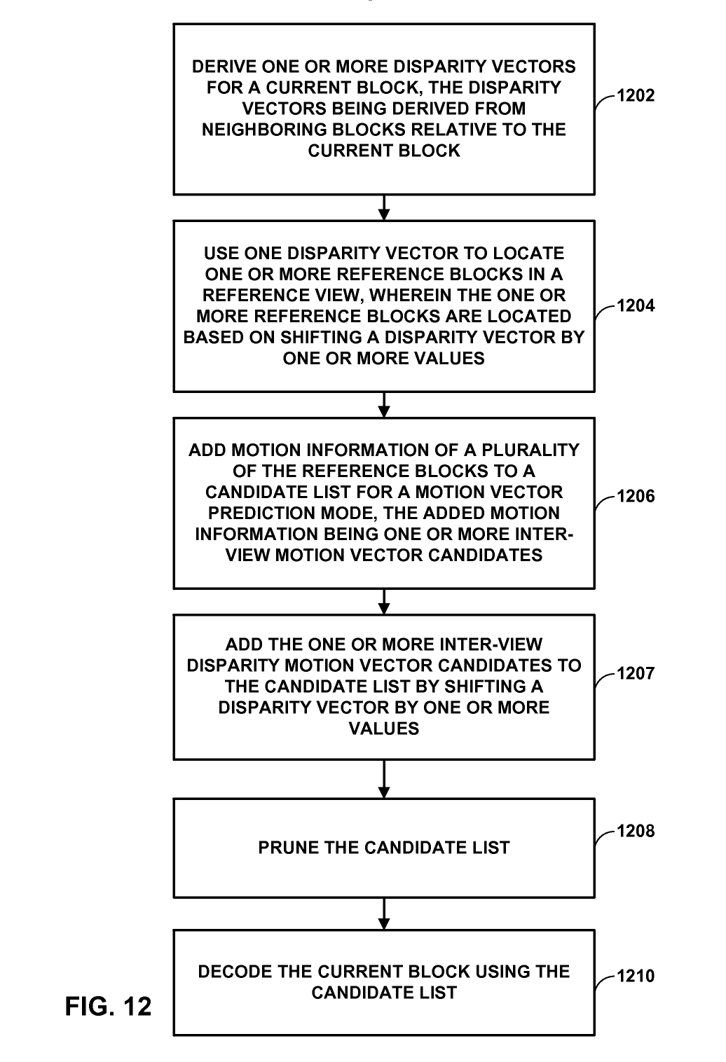

FIG. 12 is a flowchart showing an example decoding process according to the techniques of the disclosure. The techniques of FIG. 12 may be implemented by one or more structural units of video decoder 30. Video decoder 30 may be configured to derive one or more disparity vectors for a current block, the disparity vectors being derived from neighboring blocks relative to the current block (1202), and use one disparity vector to locate one or more reference blocks in a reference view, wherein the one or more reference blocks are located based on shifting a disparity vector by one or more values (1204).

Video decoder 30 may be further configured to add motion information of a plurality of the reference blocks to a candidate list for a motion vector prediction mode, the added motion information being one or more inter-view motion vector candidates (1206). Video decoder 30 may be further configured to add the one or more inter-view disparity motion vector candidates to the candidate list by shifting a disparity vector by one or more values (1207). In some examples of the disclosure, video decoder 30 may be further configured to prune the candidate list (1208). In one example of the disclosure, pruning the candidate list is based on a comparison of the one or more added inter-view motion vector candidates to spatial merging candidates. In another example of the disclosure, pruning the candidate list is based on a comparison of the one or more added inter-view motion vector candidates, without shifting, to inter-view motion vector candidates based on a shifted disparity vector.

In one example of the disclosure, video decoder 30 may be further configured to shift the one or more disparity vectors by a value from −4 to 4 horizontally, such that the shifted disparity vectors are fixed within a slice. In another example of the disclosure, video decoder 30 may be further configured to shift the one or more disparity vectors by a value based on a width of a prediction unit (PU) containing a reference block. In another example of the disclosure, video decoder 30 may be further configured to shift the one or more disparity vectors by a value based on a width of the current block.

Video decoder 30 may be further configured to decode the current block using the candidate list (1210). In one example of the disclosure, decoding the current block comprises one of decoding the current block using inter-view motion prediction and decoding the current block using inter-view residual prediction.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding multi-view video data, the method comprising:
deriving one or more disparity vectors for a current block, the disparity vectors being derived from neighboring blocks relative to the current block;
converting a disparity vector to one or more of inter-view predicted motion vector candidates and inter-view disparity motion vector candidates;
adding the one or more inter-view predicted motion vector candidates and the one or more inter-view disparity motion vector candidates to a candidate list for a motion vector prediction mode; and
decoding the current block using the candidate list.

2. The method of claim 1, wherein decoding the current block comprises one of decoding the current block using inter-view motion prediction and decoding the current block using inter-view residual prediction.

3. The method of claim 1, wherein the motion vector prediction mode is one of a skip mode, a merge mode, and an advanced motion vector prediction (AMVP) mode.

4. The method of claim 1, further comprising:
pruning the candidate list based on a comparison of the added one or more of the inter-view predicted motion vector and inter-view disparity motion vector to more than one selected spatial merging candidates.

5. A method of decoding multi-view video data, the method comprising:
deriving one or more disparity vectors for a current block, the disparity vectors being derived from neighboring blocks relative to the current block;
using one disparity vector to locate one or more reference blocks in a reference view, wherein the one or more reference blocks are located based on shifting a disparity vector by one or more values;
adding motion information of a plurality of the reference blocks to a candidate list for a motion vector prediction mode, the added motion information being one or more inter-view motion vector candidates;
adding the one or more inter-view disparity motion vector candidates to the candidate list by shifting a disparity vector by one or more values; and
decoding the current block using the candidate list.

6. The method of claim 5, further comprising shifting the one or more disparity vectors by a value from −4 to 4 horizontally, such that the shifted disparity vectors are fixed within a slice.

7. The method of claim 5, further comprising shifting the one or more disparity vectors by a value based on a width of a prediction unit (PU) containing a reference block.

8. The method of claim 5, further comprising shifting the one or more disparity vectors by a value based on a width of the current block.

9. The method of claim 5, wherein decoding the current block comprises one of decoding the current block using inter-view motion prediction and decoding the current block using inter-view residual prediction.

10. The method of claim 5, further comprising:
pruning the candidate list based on a comparison of the one or more added inter-view motion vector candidates to spatial merging candidates.

11. The method of claim 5, further comprising:
pruning the candidate list based on a comparison of the one or more added inter-view motion vector candidates without shifting to inter-view motion vector candidates based on a shifted disparity vector.

12. An apparatus configured to decode multi-view video data, the apparatus comprising:
a video decoder configured to:
derive one or more disparity vectors for a current block, the disparity vectors being derived from neighboring blocks relative to the current block;
convert a disparity vector to one or more of inter-view predicted motion vector candidates and inter-view disparity motion vector candidates;
add the one or more inter-view predicted motion vector candidates and the one or more inter-view disparity motion vector candidates to a candidate list for a motion vector prediction mode; and
decode the current block using the candidate list.

13. The apparatus of claim 12, wherein the video decoder decodes the current block by performing one of decoding the current block using inter-view motion prediction and decoding the current block using inter-view residual prediction.

14. The apparatus of claim 12, wherein the motion vector prediction mode is one of a skip mode, a merge mode, and an advanced motion vector prediction (AMVP) mode.

15. The apparatus of claim 12, wherein the video decoder is further configured to:
prune the candidate list based on a comparison of the added one or more of the inter-view predicted motion vector and inter-view disparity motion vector to more than one selected spatial merging candidates.

16. An apparatus configured to decode multi-view video data, the apparatus comprising:
a video decoder configured to:
derive one or more disparity vectors for a current block, the disparity vectors being derived from neighboring blocks relative to the current block;
use one disparity vector to locate one or more reference blocks in a reference view, wherein the one or more reference blocks are located based on shifting a disparity vector by one or more values;
add motion information of a plurality of the reference blocks to a candidate list for a motion vector prediction mode, the added motion information being one or more inter-view motion vector candidates;
add the one or more inter-view disparity motion vector candidates to the candidate list by shifting a disparity vector by one or more values; and
decode the current block using the candidate list.

17. The apparatus of claim 16, wherein the video decoder is further configured to shift the one or more disparity vectors by a value from −4 to 4 horizontally, such that the shifted disparity vectors are fixed within a slice.

18. The apparatus of claim 16, wherein the video decoder is further configured to shift the one or more disparity vectors by a value based on a width of a prediction unit (PU) containing a reference block.

19. The apparatus of claim 16, wherein the video decoder is further configured to shift the one or more disparity vectors by a value based on a width of the current block.

20. The apparatus of claim 16, wherein the video decoder decodes the current block by performing one of decoding the current block using inter-view motion prediction and decoding the current block using inter-view residual prediction.

21. The apparatus of claim 16, wherein the video decoder is further configured to:
prune the candidate list based on a comparison of the one or more added inter-view motion vector candidates to spatial merging candidates.

22. The apparatus of claim 16, wherein the video decoder is further configured to:
prune the candidate list based on a comparison of the one or more added inter-view motion vector candidates without shifting to inter-view motion vector candidates based on a shifted disparity vector.

23. An apparatus configured to decode multi-view video data, the apparatus comprising:
means for deriving one or more disparity vectors for a current block, the disparity vectors being derived from neighboring blocks relative to the current block;
means for converting a disparity vector to one or more of inter-view predicted motion vector candidates and inter-view disparity motion vector candidates;
means for adding the one or more inter-view predicted motion vector candidates and the one or more inter-view disparity motion vector candidates to a candidate list for a motion vector prediction mode; and
means for decoding the current block using the candidate list.

24. An apparatus configured to decode multi-view video data, the apparatus comprising:
means for deriving one or more disparity vectors for a current block, the disparity vectors being derived from neighboring blocks relative to the current block;
means for using one disparity vector to locate one or more reference blocks in a reference view, wherein the one or more reference blocks are located based on shifting a disparity vector by one or more values;
means for adding motion information of a plurality of the reference blocks to a candidate list for a motion vector prediction mode, the added motion information being one or more inter-view motion vector candidates;
means for adding the one or more inter-view disparity motion vector candidates to the candidate list by shifting a disparity vector by one or more values; and
means for decoding the current block using the candidate list.

25. A computer-readable storage medium storing instructions that, when executed, cause one or more processors of a device configured to decode video data to:
derive one or more disparity vectors for a current block, the disparity vectors being derived from neighboring blocks relative to the current block;
convert a disparity vector to one or more of inter-view predicted motion vector candidates and inter-view disparity motion vector candidates;
add the one or more inter-view predicted motion vector candidates and the one or more inter-view disparity motion vector candidates to a candidate list for a motion vector prediction mode; and
decode the current block using the candidate list.

26. A computer-readable storage medium storing instructions that, when executed, cause one or more processors of a device configured to decode video data to:
derive one or more disparity vectors for a current block, the disparity vectors being derived from neighboring blocks relative to the current block;
use one disparity vector to locate one or more reference blocks in a reference view, wherein the one or more reference blocks are located based on shifting a disparity vector by one or more values;
add motion information of a plurality of the reference blocks to a candidate list for a motion vector prediction mode, the added motion information being one or more inter-view motion vector candidates;
add the one or more inter-view disparity motion vector candidates to the candidate list by shifting a disparity vector by one or more values; and
decode the current block using the candidate list.

27. A method of encoding multi-view video data, the method comprising:
deriving one or more disparity vectors for a current block, the disparity vectors being derived from neighboring blocks relative to the current block;
converting a disparity vector to one or more of inter-view predicted motion vector candidates and inter-view disparity motion vector candidates;
adding the one or more inter-view predicted motion vector candidates and the one or more inter-view disparity motion vector candidates to a candidate list for a motion vector prediction mode; and
encoding the current block using the candidate list.

28. The method of claim 27, wherein encoding the current block comprises one of encoding the current block using inter-view motion prediction and encoding the current block using inter-view residual prediction.

29. The method of claim 27, wherein the motion vector prediction mode is one of a skip mode, a merge mode, and an advanced motion vector prediction (AMVP) mode.

30. The method of claim 27, further comprising:
pruning the candidate list based on a comparison of the added one or more of the inter-view predicted motion vector and inter-view disparity motion vector to more than one selected spatial merging candidates.

31. A method of encoding multi-view video data, the method comprising:
deriving one or more disparity vectors for a current block, the disparity vectors being derived from neighboring blocks relative to the current block;
using one disparity vector to locate one or more reference blocks in a reference view, wherein the one or more reference blocks are located based on shifting a disparity vector by one or more values;
adding motion information of a plurality of the reference blocks to a candidate list for a motion vector prediction mode, the added motion information being one or more inter-view motion vector candidates;
adding the one or more inter-view disparity motion vector candidates to the candidate list by shifting a disparity vector by one or more values; and
encoding the current block using the candidate list.

32. The method of claim 31, further comprising shifting the one or more disparity vectors by a value from −4 to 4 horizontally, such that the shifted disparity vectors are fixed within a slice.

33. The method of claim 31, further comprising shifting the one or more disparity vectors by a value based on a width of a prediction unit (PU) containing a reference block.

34. The method of claim 31, further comprising shifting the one or more disparity vectors by a value based on a width of the current block.

35. The method of claim 31, wherein encoding the current block comprises one of encoding the current block using inter-view motion prediction and encoding the current block using inter-view residual prediction.

36. The method of claim 31, further comprising:
pruning the candidate list based on a comparison of the one or more added inter-view motion vector candidates to spatial merging candidates.

37. The method of claim 31, further comprising:
pruning the candidate list based on a comparison of the one or more added inter-view motion vector candidates without shifting to inter-view motion vector candidates based on a shifted disparity vector.

38. An apparatus configured to encode multi-view video data, the apparatus comprising:
a video encoder configured to:
derive one or more disparity vectors for a current block, the disparity vectors being derived from neighboring blocks relative to the current block;
convert a disparity vector to one or more of inter-view predicted motion vector candidates and inter-view disparity motion vector candidates;
add the one or more inter-view predicted motion vector candidates and the one or more inter-view disparity motion vector candidates to a candidate list for a motion vector prediction mode; and
encode the current block using the candidate list.

39. The apparatus of claim 38, wherein the video encoder encodes the current block by performing one of encoding the current block using inter-view motion prediction and encoding the current block using inter-view residual prediction.

40. The apparatus of claim 38, wherein the motion vector prediction mode is one of a skip mode, a merge mode, and an advanced motion vector prediction (AMVP) mode.

41. The apparatus of claim 38, wherein the video encoder is further configured to:
prune the candidate list based on a comparison of the added one or more of the inter-view predicted motion vector and inter-view disparity motion vector to more than one selected spatial merging candidates.

42. An apparatus configured to encode multi-view video data, the apparatus comprising:
a video encoder configured to:
derive one or more disparity vectors for a current block, the disparity vectors being derived from neighboring blocks relative to the current block;
use one disparity vector to locate one or more reference blocks in a reference view, wherein the one or more reference blocks are located based on shifting a disparity vector by one or more values;
add motion information of a plurality of the reference blocks to a candidate list for a motion vector prediction mode, the added motion information being one or more inter-view motion vector candidates;
add the one or more inter-view disparity motion vector candidates to the candidate list by shifting a disparity vector by one or more values; and
encode the current block using the candidate list.

43. The apparatus of claim 42, wherein the video encoder is further configured to shift the one or more disparity vectors by a value from −4 to 4 horizontally, such that the shifted disparity vectors are fixed within a slice.

44. The apparatus of claim 42, wherein the video encoder is further configured to shift the one or more disparity vectors by a value based on a width of a prediction unit (PU) containing a reference block.

45. The apparatus of claim 42, wherein the video encoder is further configured to shift the one or more disparity vectors by a value based on a width of the current block.

46. The apparatus of claim 42, wherein the video encoder encodes the current block by performing one of encoding the current block using inter-view motion prediction and encoding the current block using inter-view residual prediction.

47. The apparatus of claim 42, wherein the video encoder is further configured to:
prune the candidate list based on a comparison of the one or more added inter-view motion vector candidates to spatial merging candidates.

48. The apparatus of claim 42, wherein the video encoder is further configured to:
prune the candidate list based on a comparison of the one or more added inter-view motion vector candidates without shifting to inter-view motion vector candidates based on a shifted disparity vector.
